(19) United States
(12) Patent Application Publication
(10) Pub. No.: US 2017/0241048 A1
(43) Pub. Date: Aug. 24, 2017

(54) HIGH-STRENGTH COPOLYMERIZED ARAMID FIBER AND PREPARING METHOD THEREFOR

(71) Applicant: KOLON INDUSTRIES, INC., Gwacheon-si, Gyeonggi-do (KR)

(72) Inventors: Nam Dae GU, Yongin-si (KR); Kyeong Hwan RHO, Yongin-si (KR)

(73) Assignee: KOLON INDUSTRIES, INC., Gwacheon-si, Gyeonggi-do (KR)

(21) Appl. No.: 15/502,820

(22) PCT Filed: Aug. 19, 2015
(86) PCT No.: PCT/KR2015/008650

§ 371 Date: Feb. 9, 2017

(30) Foreign Application Priority Data
Aug. 20, 2014 (KR) 10-2014-0108345

(51) Int. Cl. D01F 6/80; C08G 69/00; D01F 1/02; D01D 5/00

(52) U.S. Cl. CPC D01F 6/805; D01D 5/00; C08G 69/00; D01F 1/02; D10B 2331/021; D10B 2401/063; D10B 2401/061

(57) ABSTRACT

Disclosed is a high-strength copolymerized aramid fiber which includes aramid copolymers containing an aromatic group substituted with a cyano group (—CN), so as to have an intrinsic viscosity (IV) of 6.0 to 8.5, a polydispersity index (PDI) of 1.5 to 2.0, a strength of 23 to 32 g/d, and an elastic modulus of 1,100 to 1,300 g/d. The high-strength copolymerized aramid fiber may be prepared by a method which includes, when para-phenylenediamine, cyano-para-phenylenediamine, and terephthaloyl dichloride are sequentially added to an organic solvent and reacted together to prepare a copolymerized aramid fiber, adding and dispersing a neutralizing agent in the organic solvent before the reaction of the para-phenylenediamine, cyano-para-phenylenediamine and terephthaloyl dichloride, which were dissolved in the organic solvent.

### TECHNICAL FIELD

The present invention relates to a high-strength copolymerized aramid fiber and a method for preparing the same, and more particularly, to a high-strength copolymerized aramid fiber which includes aramid copolymers containing an aromatic group substituted with a cyano group (—CN), so as to have high intrinsic viscosity (IV), low polydispersity index (PDI) and high strength and elastic modulus. Further, the present invention provides a method for preparing a high-strength copolymerized aramid fiber, in which hydrogen chloride (HCl) generated during polymerization of the aramid copolymer is directly removed with a neutralizing agent dispersed in an organic solvent while being changed into a metal salt so as to prevent generation of acid crumbs and, instead, generate an additional salt, thus delaying gelation due to the acid crumbs, that is, extending a polymerization time so as to increase the intrinsic viscosity (IV) of the aramid copolymer while narrowing a molecular weight distribution, and, to improve a solubility of aramid polymer in the organic solvent due to the generation of the additional salt, thereby favorably spinning the aramid copolymer having high intrinsic viscosity (IV) even without using sulfuric acid.

### BACKGROUND ART

Aromatic polyamide, commonly referred to as an aramid, includes a para-based aramid having a structure in which benzene rings are linked linearly through an amide group (—CONH) and a meta-based aramid which has a linkage structure different from the para-based aramid.

The para-based aramid has excellent characteristics such as a high strength, high elasticity and low shrinkage. Since the para-based aramid has a high enough strength so as to be able to lift a two-ton vehicle with a thin cable made thereof having a thickness of about 5 mm, it is widely used for bulletproofing, as well as in a variety of applications in advanced industries of an aerospace field.

Further, the aramid is carbonized and becomes black at 500° C. or more, thus being also spotlighted in fields requiring high heat-resistant properties.

The preparation method of aramid fiber has been explained well in Korean Patent Registration No. 10-0910537 owned by the present applicant. According to this registered patent, a mixture solution is prepared by dissolving aromatic diamine in a polymerization solvent, followed by adding aromatic diacid to the above solution to prepare an aramid polymer. Next, the aramid polymer is dissolved in a sulfuric acid solvent to prepare a spin dope, the spin dope is spun, followed by conducting coagulation, washing and drying processes in this order, thereby finally completing an aramid fiber.

However, if the aramid fiber is prepared according to the above-described processes, an aramid polymer in a solid state is prepared and again dissolved in a sulfuric acid solvent to prepare a spin dope, followed by spinning the same. Therefore, a manufacturing process becomes complicated, is harmful for a human body, and may cause a problem such as a decrease in durability due to corrosion of an apparatus.

Moreover, since the sulfuric acid solvent used for dissolving an aramid polymer having high chemical resistance and removed after spinning often causes environmental pollution, it should be appropriately treated after the use. Costs for treatment of such spent sulfuric acid usually reduce economic advantages of the aramid fiber.

In order to solve the above problems, Korean Patent Registration No. 10-171994 and Korean Patent Laid-Open Publication No. 10-2013-0075202 disclose a method for fabricating an aramid fiber directly using a copolymerized aramid polymerization solution as a spin dope, thus preparing the aramid fiber while not requiring a sulfuric acid solvent.

More particularly, in the above prior arts, a solid-phase aramid copolymer is prepared by adding terephthaloyl dichloride to an organic solvent in which para-phenylenediamine and cyano-para-phenylenediamine have been dissolved, and reacting the same. After completing the polymerization, the obtained solid-phase aramid copolymer is ground and uniformly dissolved by adding a neutralizing agent such as calcium hydroxide to prepare a spin dope, followed by spinning and coagulating the spin dope thus to fabricate a copolymerized aramid fiber.

According to the above conventional method, the aramid fiber could be fabricated without using a sulfuric acid solvent. However, paraphenylene, cyano-para-phenylenediamine and terephthaloyl dichloride react together to form hydrogen chloride (HCl), which generates acid crumbs and thus causes fast gelation. That is, since a reaction time is shortened, the polymerized aramid copolymer has lower intrinsic viscosity of about 5.0 and a polydispersity index (PDI) of about 2.2, hence causing a problem of enlarging a molecular weight distribution. As a result, the spin dope formed according to the conventional method has poor liquid crystalline properties to deteriorate spinning properties. The conventional method involved limitations in improving strength and elastic modulus of the fabricated aramid fiber.

In particular, when the polydispersity index (PDI) of the aramid copolymer is about 2.2, a molecular weight distribution is enlarged and a distribution of polymer chains having a low molecular weight (polymer chains having a short length) is increased. Whereas such a low molecular weight polymer chain (polymer chains having a short length) is present on a skin layer of the spun copolymerized aramid fiber, thus increasing end portions of the polymer chains inside the skin layer. As a result, when tensioning the copolymerized aramid fiber, it causes a defect of early cutting off the end portions of the polymer chains which, in turns, causes a deterioration in the strength and elastic modulus.

Further, even though the intrinsic viscosity (IV) of the aramid copolymer is low about 5.0, a length of the polymer chains is decreased, hence causing a deterioration in the strength and elastic modulus of the copolymerized aramid fiber fabricated above.

Furthermore, the above conventional method requires a long period of time of 24 hours or more for preparing a spin dope by introducing a neutralizing agent into the aramid copolymer obtained after the polymerization, in order to uniformly dissolve a solid-phase aramid polymer, and therefore, causing a problem of decreasing productivity of the spin dope.

### DISCLOSURE

### Technical Problem

An object of the present invention is to provide a high-strength copolymerized aramid fiber which includes aramid copolymers containing an aromatic group substituted with a cyano group (—CN), so as to have a high intrinsic viscosity (IV), low polydispersity index (PDI) to narrow a molecular weight distribution, and high strength and elastic modulus.

Another object of the present invention is to provide a method for preparing a high-strength copolymerized aramid fiber, in which hydrogen chloride (HCl) generated during polymerization of para-phenylenediamine, cyano-para-phenylenediamine and terephthaloyl dichloride is directly removed with a neutralizing agent dispersed in an organic solvent while being changed into a metal salt so as to prevent generation of acid crumbs and, instead, generate an additional salt, thus delaying gelation due to the acid crumbs, that is, extending a polymerization time, so as to increase the intrinsic viscosity (IV) of the aramid copolymer while narrowing a molecular weight distribution and, to improve a solubility of aramid polymer in the organic solvent due to the generation of the additional salt, thereby favorably spinning the aramid copolymer having high intrinsic viscosity (IV) even without using sulfuric acid.

### Technical Solution

In order to accomplish the above objects, the present invention includes: when para-phenylenediamine, cyano-para-phenylenediamine and terephthaloyl dichloride are sequentially added to an organic solvent and reacted together to prepare a spin dope for copolymerized aramid fibers, introducing and dispersing a neutralizing agent in the organic solvent before the reaction of the phenylenediamine, cyano-para-phenylenediamine and terephthaloyl dichloride dissolved in the organic solvent.

In an embodiment of the present invention, the neutralizing agent may be introduced and dispersed in an organic solvent in which para-phenylenediamine and cyano-para-phenylenediamine are not soluble. In another embodiment of the present invention, the neutralizing agent may be firstly introduced and dispersed in an organic solvent before dissolving terephthaloyl dichloride in the organic solvent in which para-phenylenediamine and cyano-para-phenylenediamine have been dissolved.

Further, in another embodiment of the present invention, before adding and reacting terephthaloyl dichloride in an organic solvent in which the neutralizing agent has been dispersed and para-phenylenediamine and cyano-para-phenylenediamine have been dissolved, the organic solvent may be cooled to a temperature of −10° C. to −1° C.

### Advantageous Effects

According to the present invention, hydrogen chloride (HCl) generated during polymerization of para-phenylenediamine, cyano-para-phenylenediamine and terephthaloyl dichloride is directly removed by the neutralizing agent dispersed in the solvent while being changed into a metal salt, and thus acid crumbs are not generated but an additional salt is rather generated. Therefore, gelation due to the acid crumbs is delayed, that is, a reaction time is extended to generate an additional salt so as to produce aramid copolymers that exhibit excellent solubility in an organic solvent while having high intrinsic viscosity (IV) and low polydispersity index (PDI). Further, using the aramid copolymer may fabricate a high-strength copolymerized aramid fiber with excellent spinning properties even without using sulfuric acid.

### DESCRIPTION OF DRAWINGS

Hereinafter, the present invention will be described in detail.

Embodiments of the present invention described below are proposed as illustrative examples to help understanding the present invention but do not particularly limit the subject matters of the present invention to be protected. Further, it will be apparent to those skilled in the art that various alterations and modifications of the present invention are possible within the technical spirit and scope of the present invention. Accordingly, the present invention includes inventions described in the claims and all of the alterations and modification within equivalents thereof.

According to an aspect of the present invention, there is provided a method for fabricating a high-strength copolymerized aramid fiber, including: (i) introducing a neutralizing agent into an organic solvent then dispersing the same; (ii) dissolving para-phenylenediamine and cyano-para-phenylenediamine in a molar ratio of 1:9 to 9:1 in the organic solvent in which the neutralizing agent is dispersed; (iii) adding terephthaloyl dichloride to the organic solvent, in which the neutralizing agent is dispersed, and the para-phenylenediamine and the cyano-para-phenylenediamine were dissolved, in an equal molar amount to a total amount of the para-phenylenediamine and cyano-para-phenylenediamine, then, reacting the same thus to prepare a spin dope; and (iv) spinning the spin dope to fabricate a copolymerized aramid fiber.

According to another aspect of the present invention, there is provided a method for fabricating a high-strength copolymerized aramid fiber, including: (i) dissolving para-phenylenediamine and cyano-para-phenylenediamine in a molar ratio of 1:9 to 9:1 in an organic solvent; (ii) introducing a neutralizing agent into the organic solvent, in which the para-phenylenediamine and the cyano-para-phenylenediamine were dissolved, then, dispersing the same therein; (iii) adding terephthaloyl dichloride to the organic solvent, in which the neutralizing agent is dispersed, and the para-phenylenediamine and the cyano-para-phenylenediamine were dissolved, in an equal molar amount to a total amount of the para-phenylenediamine and cyano-para-phenylenediamine, then, reacting the same thus to prepare a spin dope; and (iv) spinning the spin dope to fabricate a copolymerized aramid fiber.

More particularly, the present invention may introduce a neutralizing agent into an organic solvent in advance before introducing para-phenylenediamine and cyano-para-phenylenediamine to the organic solvent. Otherwise, after introducing the para-phenylenediamine and the cyano-para-phenylenediamine to the organic solvent and before introducing the terephthaloyl dichloride therein, the neutralizing agent may be introduced into the organic solvent.

The neutralizing agent used herein may be calcium hydroxide, calcium oxide, sodium hydroxide, lithium carbonate, etc. and an added amount of the neutralizing agent may range from 50 to 120% by mole (‘mol. %’) to the organic solvent.

The neutralizing agent may play a role of removing hydrogen chloride (HCl) generated during polymerization of the para-phenylenediamine, cyano-para-phenylenediamine and terephthaloyl dichloride while generating an additional salt so as to improve the solubility of polymer in the spin dope.

The organic solvent may include, for example, N-methyl-2-pyrrolidone (NMP), N,N-dimethylacetamide (DMAc), hexamethyl phosphoamide (HMPA), N,N,N′,N′-tetramethylurea (TMU), N,N-dimethylformamide (DMF), or a mixture thereof.

With regard to an embodiment of the present invention, first of all, the neutralizing agent may be introduced into the organic solvent and dispersed therein.

Next, the para-phenylenediamine and cyano-para-phenylenediamine are dissolved in the organic solvent including the neutralizing agent dispersed therein in a molar ratio of 1:9 to 9:1. Herein, in order to increase a polymerization degree, an inorganic salt is preferably added to the solution.

The inorganic salt is added to increase a polymerization degree of aromatic polyamide, and may include, for example, alkaline metal halide salts or alkali-earth metal halide salts such as CaCl₂, LiCl, NaCl, KCl, LiBr and KBr. These inorganic salts may be added alone or in combination of two or more thereof.

Preferably, the inorganic salt is added in an amount of 2 to 5% by weight (‘wt. %’) to a weight of the organic solvent.

Next, terephthaloyl dichloride is added to the organic solvent, in which the neutralizing agent is dispersed, and the para-phenylenediamine and the cyano-para-phenylenediamine were dissolved, in an equal molar amount to a total amount of the para-phenylenediamine and cyano-para-phenylenediamine, followed by reacting the same to prepare a spin dope. Then, spinning the spin dope fabricates a copolymerized aramid fiber.

According to a particular embodiment, after spinning the spin dope through a spinneret, coagulation, washing, drawing and winding may be executed to fabricate a copolymerized aramid fiber.

The present invention may further include cooling the organic solvent in which the neutralizing agent is dispersed, and the para-phenylenediamine and the cyano-para-phenylenediamine were dissolved, to a temperature of −10° C. to −1° C. before the addition and reaction of the terephthaloyl dichloride in the organic solvent in which the neutralizing agent is dispersed, and the para-phenylenediamine and the cyano-para-phenylenediamine were dissolved.

The cooling process may suppress polymerization heat generated during polymerization of the para-phenylenediamine, cyano-para-phenylenediamine and terephthaloyl dichloride, as well neutralization heat generated during neutralization of the neutralizing agent and hydrogen chloride (HCl). Therefore, the polymerization of the para-phenylenediamine, cyano-para-phenylenediamine and terephthaloyl dichloride may be continued for a longer period of time. As a result, the polymerized aramid copolymer may have higher intrinsic viscosity (IV).

According to the present invention, the hydrogen chloride (HCl) generated by polymerization of the para-phenylenediamine, cyano-para-phenylenediamine and terephthaloyl dichloride is directly removed by the neutralizing agent dispersed in the organic solvent while being changed into a metal salt. Therefore, acid crumbs are not generated but an additional salt is rather generated to delay gelation due to the acid crumbs. In other words, intrinsic viscosity (IV) of the aramid copolymer becomes higher while narrowing a molecular weight distribution by increasing a polymerization time, and a solubility of the aramid polymer in the organic solvent is improved due to the generation of the additional salt. As a result, the aramid copolymer having high intrinsic viscosity (IV) as described above may be favorably spun to fabricate a high strength copolymerized aramid fiber without using sulfuric acid.

More particularly, when the polydispersity index (PDI) of the aramid copolymer ranges from 1.5 to 2.0, a molecular weight distribution becomes narrow and thus a distribution of high molecular weight polymer chains (polymer chains having a long length) is increased. Herein, the high molecular weight polymer chains (polymer chains having a long length) are present on a skin layer of the spun copolymerized aramid fiber, and when tensioning the copolymerized aramid fiber, end portions of the polymer, which are early cut off and act as a defect, are decreased thus to greatly improve the strength and elastic modulus of the fabricated copolymerized aramid fiber.

Further, when the polydispersity index (PDI) of the aramid copolymer ranges from 1.5 to 2.0, a molecular weight distribution becomes narrow and thus a distribution of high molecular weight polymer chains (with a long length) is increased to improve liquid crystal properties of dissolved spin dope. As a result, spinning properties may be enhanced.

Further, when the intrinsic viscosity (IV) of the aramid copolymer is high about 6.0 to 8.5, a length of the polymer chains becomes longer and, for reasons mentioned above, the strength and elastic modulus of the copolymerized aramid fiber may be improved.

Hereinafter, the present invention will be described in more detail with reference to examples and comparative examples.

However, the following examples are proposed as preferred embodiments of the present invention only, and it is duly not construed that the scope of the present invention is particularly limited to these examples.

### Example 1

30 g of N-methyl-2-pyrrolidone (organic solvent) including 3 wt. % of calcium chloride (inorganic salt) was fed to a reactor under a nitrogen atmosphere, and 6.99 g of calcium oxide (neutralizing agent) was added and dispersed therein.

Then, 5.7 g of para-phenylenediamine and 10.55 g of cyano-para-phenylenediamine were added to the organic solvent including the neutralizing agent dispersed therein, followed by dissolving the same in the reactor to prepare a mixture solution.

Next, 26.79 g of terephthaloyl dichloride was added to the mixture solution in which the neutralizing agent is dispersed, and the para-phenylenediamine and the cyano-para-phenylenediamine were dissolved, followed by reacting the solution thus to prepare a spin dope including aramid copolymer uniformly dissolved therein.

As a result of visually observing the prepared spin dope, a gel or solid phase was not monitored, therefore, it may be seen that the aramid copolymer in the spin dope has excellent solubility.

Following this, after extruding the spin dope through a spinneret, the spin dope sequentially passed through an air gap and a coagulant solution, thus forming a multi-filament having a linear density of 3,000 deniers. A pressure of a spin pack was 2,800 psi while a spin velocity was 600 meter per minute (mpm).

Thereafter, the multi-filament was washed and the washed multi-filament was dried and drawn in a dry roller set up at a temperature of 150° C. The drawn multi-filament was subjected to heat treatment and winding at 250° C., thus fabricating a copolymerized aramid fiber.

Physical properties of the fabricated copolymerized aramid fiber were measured, and results thereof are shown in Table 1 below.

### Example 2

g of N-methyl-2-pyrrolidone (organic solvent) including 3 wt. % of calcium chloride (inorganic salt) was fed to a reactor under a nitrogen atmosphere, and 6.99 g of calcium oxide (neutralizing agent) was added and dispersed therein.

Then, 5.7 g of para-phenylenediamine and 10.55 g of cyano-para-phenylenediamine were added to the organic solvent including the neutralizing agent dispersed therein, followed by dissolving the same in the reactor to prepare a mixture solution.

Next, 26.79 g of terephthaloyl dichloride was added to the mixture solution in which the neutralizing agent is dispersed, and the para-phenylenediamine and the cyano-para-phenylenediamine were dissolved, followed by reacting the solution at −90° C. thus to prepare a spin dope including aramid copolymer uniformly dissolved therein.

As a result of visually observing the prepared spin dope, a gel or solid phase was not monitored, therefore, it may be seen that the aramid copolymer in the spin dope has excellent solubility.

Following this, after extruding the spin dope through a spinneret, the spin dope sequentially passed through an air gap and a coagulant solution, thus forming a multi-filament having a linear density of 3,000 deniers. A pressure of a spin pack was 2,800 psi while a spin velocity was 600 meter per minute (mpm).

Thereafter, the multi-filament was washed and the washed multi-filament was dried and drawn in a dry roller set up at a temperature of 150° C. The drawn multi-filament was subjected to heat treatment and winding at 250° C., thus fabricating a copolymerized aramid fiber.

Physical properties of the fabricated copolymerized aramid fiber were measured, and results thereof are shown in Table 1 below.

### Example 3

300 g of N-methyl-2-pyrrolidone (organic solvent) including 3 wt. % of calcium chloride (inorganic salt) was fed to a reactor under a nitrogen atmosphere, and 5.7 g of para-phenylenediamine and 10.55 g of cyano-para-phenylenediamine were added and dissolved therein.

Then, 6.99 g of calcium oxide (neutralizing agent) was added to the above organic solvent in which the para-phenylenediamine and the cyano-para-phenylenediamine were dissolved, followed by dispersing the same.

Next, the mixture solution in which the neutralizing agent is dispersed, and the para-phenylenediamine and the cyano-para-phenylenediamine were dissolved, was cooled to −5° C., followed by adding 25.78 g of terephthaloyl dichloride thereto and reacting the same thus to prepare a spin dope including aramid polymer uniformly dissolved therein.

As a result of visually observing the prepared spin dope, a gel or solid phase was not monitored, therefore, it may be seen that the aramid polymer in the spin dope has excellent solubility.

Following this, after extruding the spin dope through a spinneret, the spin dope sequentially passed through an air gap and a coagulant solution, thus forming a multi-filament having a linear density of 3,000 deniers. A pressure of a spin pack was 2,800 psi while a spin velocity was 600 meter per minute (mpm).

Thereafter, the multi-filament was washed and the washed multi-filament was dried and drawn in a dry roller set up at a temperature of 150° C. The drawn multi-filament was subjected to heat treatment and winding at 250° C., thus fabricating an aramid fiber.

Physical properties of the fabricated aramid fiber were measured, and results thereof are shown in Table 1 below.

### Example 4

300 g of N-methyl-2-pyrrolidone (organic solvent) including 3 wt. % of calcium chloride (inorganic salt) was fed to a reactor under a nitrogen atmosphere, and 5.7 g of para-phenylenediamine and 10.55 g of cyano-para-phenylenediamine were added and dissolved therein.

Then, 6.99 g of calcium oxide (neutralizing agent) was added to the above organic solvent in which the para-phenylenediamine and the cyano-para-phenylenediamine were dissolved, followed by dispersing the same.

Next, 25.78 g of terephthaloyl dichloride was added to the mixture solution in which the neutralizing agent is dispersed, and the para-phenylenediamine and the cyano-para-phenylenediamine were dissolved, followed by reacting the solution thus to prepare a spin dope including aramid polymer uniformly dissolved therein.

As a result of visually observing the prepared spin dope, a gel or solid phase was not monitored, therefore, it may be seen that the aramid polymer in the spin dope has excellent solubility.

Following this, after extruding the spin dope through a spinneret, the spin dope sequentially passed through an air gap and a coagulant solution, thus forming a multi-filament having a linear density of 3,000 deniers. A pressure of a spin pack was 2,800 psi while a spin velocity was 600 meter per minute (mpm).

Thereafter, the multi-filament was washed and the washed multi-filament was dried and drawn in a dry roller set up at a temperature of 150° C. The drawn multi-filament was subjected to heat treatment and winding at 250° C., thus fabricating an aramid fiber.

Physical properties of the fabricated aramid fiber were measured, and results thereof are shown in Table 1 below.

### Comparative Example 1

300 g of N-methyl-2-pyrrolidone (organic solvent) including 3 wt. % of calcium chloride (inorganic salt) was fed to a reactor under a nitrogen atmosphere, and 5.7 g of para-phenylenediamine and 10.55 g of cyano-para-phenylenediamine were added and dissolved therein to prepare a mixture solution.

Then, 26.79 g of terephthaloyl dichloride was added to the above mixture solution in which the para-phenylenediamine and the cyano-para-phenylenediamine were dissolved, followed by reacting the same to prepare a solid-phase aramid copolymer.

Next, the prepared aramid copolymer was dissolved with calcium hydroxide (neutralizing agent) for 12 hours, thus preparing a spin dope.

Following this, after extruding the spin dope through a spinneret, the spin dope sequentially passed through an air gap and a coagulant solution, thus forming a multi-filament having a linear density of 3,000 deniers. A pressure of a spin pack was 2,800 psi while a spin velocity was 600 meter per minute (mpm).

Thereafter, the multi-filament was washed and the washed multi-filament was dried and drawn in a dry roller set up at a temperature of 150° C. The drawn multi-filament was subjected to heat treatment and winding at 250° C., thus fabricating a copolymerized aramid fiber.

Physical properties of the fabricated copolymerized aramid fiber were measured, and results thereof are shown in Table 1 below.

TABLE 1

| | Intrinsic | Polydispersity | | Elastic |
|---|---|---|---|---|
| | viscosity | index | Strength | modulus |
| Category | (IV) | (PDI) | (g/d) | (g/d) |
| Example 1 | 6.2 | 1.95 | 25 | 1,100 |
| Example 2 | 8.3 | 1.57 | 30 | 1,200 |
| Example 3 | 7.8 | 1.62 | 28 | 1,150 |
| Example 4 | 7.0 | 1.80 | 26 | 1,100 |
| Comparative | 5.0 | 2.40 | 22 | 900 |
| Example 1 | | | | |

A molecular weight distribution of the copolymerized aramid fiber was assessed by following procedures.

Polydispersity Index (PDI)

The aramid fiber was dissolved in dimethylformamide (DMF) to prepare a sample. A weight average molecular weight and a number average molecular weight of the prepared sample were determined, respectively, using a Shodex GPC column of Waters manual injector kit at a temperature of 35° C. under a flow rate of 10 ml/min through a gel permeation chromatography equipped with a refraction index detector. With the measured values, a molecular weight distribution was calculated by Equation 1 below.

Polydispersity index (PDI)=Mw/Mn [Equation 1]

(wherein Mw denotes a weight average molecular weight, and Mn denotes a number average molecular weight).

Strength (g/d) and Elastic Modulus (g/d)

The strength and elastic modulus of the aramid fiber were determined according to an ASTM D885 test method.

More particularly, the strength and elastic modulus were measured by tensioning the sample in Instron tester (Instron Engineering Corp, canton, Mass) until the copolymerized aramid fiber having a length of 25 cm is broken.

Herein, a tensile velocity was set to 300 m/min and an initial load was set to fineness× 1/30 g.

After testing 5 samples, an average of tested values was estimated.

The elastic modulus was estimated from a slope on S—S curve, while the strength was calculated from the maximum load.

Intrinsic Viscosity (IV)

An intrinsic viscosity (IV) is defined by a following equation.

IV=ln(ηrel)/C

(wherein C denotes a concentration of a polymer solution (a solution prepared by dissolving 0.5 g of polymer in 100 ml of concentrated sulfuric acid), and the relative viscosity (ηrel) is a ratio of flow times between the polymer solution and the solvent, which were measured by a capillary viscometer at 30° C. Unless stated otherwise, the intrinsic viscosity was measured using a concentrated sulfuric acid solvent with a concentration of 95 to 98%).

### INDUSTRIAL APPLICABILITY

The high-strength copolymerized aramid fiber of the present invention may be useful as a raw material for fiber/resin complex substances applied to bullet-proof materials or automobile parts.

1. A high-strength copolymerized aramid fiber, comprising aramid copolymers which contain an aromatic group substituted with a cyano group (—CN), so as to have an intrinsic viscosity (IV) of 6.0 to 8.5, a polydispersity index (PDI) of 1.5 to 2.0, and a strength of 23 to 32 g/d.

2. The high-strength copolymerized aramid fiber according to claim 1, wherein the elastic modulus of the high-strength copolymerized aramid fiber ranges from 1,100 to 1,300 g/d.

3. The high-strength copolymerized aramid fiber according to claim 1, wherein the aramid copolymer containing the aromatic group substituted with a cyano group (—CN) has a repeat unit represented by Formula I below:
[Formula I]
—(NH-A-NHCO—Ar—CO)— (I)
(wherein Ar is an aromatic group represented by Formula II below, and A is an aromatic group represented by Formula III below or an aromatic group having a ratio of the aromatic group of Formula II below to the aromatic group of Formula III below in a range of 1:9 to 9:1)

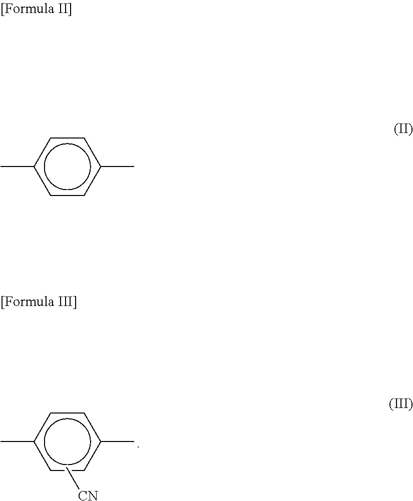

4. A method for fabricating a high-strength copolymerized aramid fiber, comprising:
(i) introducing a neutralizing agent into an organic solvent then dispersing the same;
(ii) dissolving para-phenylenediamine and cyano-para-phenylenediamine in a molar ratio of 1:9 to 9:1 in the organic solvent in which the neutralizing agent is dispersed;
(iii) adding terephthaloyl dichloride to the organic solvent, in which the neutralizing agent is dispersed, and the para-phenylenediamine and the cyano-para-phenylenediamine were dissolved, in an equal molar amount to a total amount of the para-phenylenediamine and cyano-para-phenylenediamine, then, reacting the same thus to prepare a spin dope; and
(iv) spinning the spin dope to fabricate a copolymerized aramid fiber.

5. The method for fabricating a high-strength copolymerized aramid fiber according to claim 4, further comprising cooling the organic solvent to −10° C. to −1° C. before the addition and reaction of terephthaloyl dichloride in the organic solvent in which the neutralizing agent is dispersed, and the para-phenylenediamine and the cyano-para-phenylenediamine were dissolved.

6. The method for fabricating a high-strength copolymerized aramid fiber according to claim 4, wherein the neutralizing agent is added and dispersed in an amount of 50 to 120% by moles to the organic solvent.

7. The method for fabricating a high-strength copolymerized aramid fiber according to claim 4, wherein the neutralizing agent is one selected from calcium hydroxide, calcium oxide, sodium hydroxide and lithium carbonate.

8. The method for fabricating a high-strength copolymerized aramid fiber according to claim 4, wherein the organic solvent is one selected from N-methyl-2-pyrrolidone, N,N-dimethylacetamide, hexamethylphosphoamide, N,N,N′,N′-tetramethylurea and N,N-dimethylformamide.

9. The method for fabricating a high-strength copolymerized aramid fiber according to claim 4, wherein the spin dope is spun through a spinneret, followed by conducting coagulation, washing, drawing and winding the spin dope.

10. A method for fabricating a high-strength copolymerized aramid fiber, comprising:
(i) dissolving para-phenylenediamine and cyano-para-phenylenediamine in a molar ratio of 1:9 to 9:1 in an organic solvent;
(ii) introducing a neutralizing agent into the organic solvent, in which the para-phenylenediamine and the cyano-para-phenylenediamine were dissolved, then, dispersing the same therein;
(iii) adding terephthaloyl dichloride to the organic solvent, in which the neutralizing agent is dispersed, and the para-phenylenediamine and the cyano-para-phenylenediamine were dissolved, in an equal molar amount to a total amount of the para-phenylenediamine and cyano-para-phenylenediamine, then, reacting the same thus to prepare a spin dope; and
(iv) spinning the spin dope to fabricate a copolymerized aramid fiber.

11. The method for fabricating a high-strength copolymerized aramid fiber according to claim 10, further comprising cooling the organic solvent to −10° C. to −1° C. before the addition and reaction of terephthaloyl dichloride in the organic solvent in which the neutralizing agent is dispersed, and the para-phenylenediamine and the cyano-para-phenylenediamine were dissolved.

12. The method for fabricating a high-strength copolymerized aramid fiber according to claim 10, wherein the neutralizing agent is added and dispersed in an amount of 50 to 120% by moles to the organic solvent.

13. The method for fabricating a high-strength copolymerized aramid fiber according to claim 10, wherein the neutralizing agent is one selected from calcium hydroxide, calcium oxide, sodium hydroxide and lithium carbonate.

14. The method for fabricating a high-strength copolymerized aramid fiber according to claim 10, wherein the organic solvent is one selected from N-methyl-2-pyrrolidone, N,N-dimethylacetamide, hexamethylphosphoamide, N,N,N′,N′-tetramethylurea and N,N-dimethylformamide.

15. The method for fabricating a high-strength copolymerized aramid fiber according to claim 10, wherein the spin dope is spun through a spinneret, followed by conducting coagulation, washing, drawing and winding the spin dope.

16. The method for fabricating a high-strength copolymerized aramid fiber according to claim 5, wherein the neutralizing agent is added and dispersed in an amount of 50 to 120% by moles to the organic solvent.

17. The method for fabricating a high-strength copolymerized aramid fiber according to claim 5, wherein the neutralizing agent is one selected from calcium hydroxide, calcium oxide, sodium hydroxide and lithium carbonate.

18. The method for fabricating a high-strength copolymerized aramid fiber according to claim 5, wherein the organic solvent is one selected from N-methyl-2-pyrrolidone, N,N-dimethylacetamide, hexamethylphosphoamide, N,N,N′,N′-tetramethylurea and N,N-dimethylformamide.

19. The method for fabricating a high-strength copolymerized aramid fiber according to claim 5, wherein the spin dope is spun through a spinneret, followed by conducting coagulation, washing, drawing and winding the spin dope.
